(19) United States
(12) Patent Application Publication
(10) Pub. No.: US 2008/0239386 A1
(43) Pub. Date: Oct. 2, 2008

(54) Network apparatus to be connected with a network

(75) Inventor: Satoru Yanagi, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/076,578

(22) Filed: Mar. 20, 2008

(30) Foreign Application Priority Data
Mar. 27, 2007 (JP) 2007-082406

(51) Int. Cl. G06F 3/12

(52) U.S. Cl. 358/1.15

(57) ABSTRACT

A network apparatus comprises an address storing device, a keyword storing device, an error sensing device, an access device, a search device, and an output device. The address storing device stores an address of a web page on the network. The keyword storing device stores a keyword related to the network apparatus. The error sensing device senses error occurrence in the network apparatus. The access device tries to access the address when the error sensing device senses error occurrence. The search device sends the keyword to a search engine on the network and receives a result of the search when the access device fails to access the address. The output device outputs the result of the search.

### CROSS-REFERENCE TO RELATED APPLICATION

This application claims priority to Japanese Patent Application No. 2007-082406 filed on Mar. 27, 2007, the contents of which are hereby incorporated by reference into the present application.

### BACKGROUND OF THE INVENTION

1. Field of the Invention

The present invention relates to a network apparatus to be connected with a network.

2. Description of the Related Art

A device exists that, when an error occurs, displays information on how to recover from the error (below, this is termed error recovery information). For example, when a paper jam occurs, many printers display information on how to recover from the paper jam. A user can unjam the printer by operating the printer while looking at the error recovery information.

Error recovery information may be made public on a network by the manufacturer, etc., of the device. For example, a technique is taught in Japanese Patent Application Publication No. 2001-312464 for making error recovery information public on a www server. The www server has a database that stores error recovery information corresponding to various types of errors that can occur at a user terminal. The user terminal stores the address of the www server. When an error has occurred, the user terminal accesses the www server and sends information identifying the type of error to the www server. The www server identifies the error recovery information related to that type of error from the database, and returns the identified error recovery information to the user terminal. The user terminal can thus display the error recovery information.

### BRIEF SUMMARY OF THE INVENTION

With the user terminal of Japanese Patent Application Publication No. 2001-312464, a situation may occur in which the error recovery information cannot be obtained. For example, the error recovery information cannot be obtained in the case where the address of the www server has been changed or the error recovery information has been deleted from the www server. Further, the error recovery information cannot be obtained in the case where the manufacturer, etc., has terminated the public service of the error recovery information.

The technique disclosed in the present specification teaches devices capable of obtaining error recovery information even in the case where the error recovery information cannot be obtained in spite of accessing an address on a network.

A network apparatus connected with a network is set forth in the present specification. This network apparatus encompasses all devices connected with a network. For example, the network apparatus may be a personal computer, a portable terminal, a printer, a scanner, a copier, a multi function device, etc. Further, the network may be the Internet, or may be a local area network.

The above network apparatus comprises an address storing device, a keyword storing device, an error sensing device, an access device, a search device and an output device. The address storing device can store an address of a web page on the network. The keyword storing device can store a keyword related to the network apparatus. The error sensing device senses error occurrence in the network apparatus. The access device tries to access the address when the error sensing device senses error occurrence. The search device sends the keyword to a search engine on the network and receives a result of the search in the case where the access device fails to access the address. The output device outputs the result of the search. Moreover, the term “output” includes displaying, printing, transmission to an external machine, etc.

In this network apparatus, when an occurrence of an error has been sensed, the access device tries to access the address that is being stored in the address storing device. However, in the case where the address of a web page recording error recovery information has been changed, or the like, the access device fails to access the address. In this case, the search device sends the keyword to the search engine on the network, and obtains the search results. With the search engine on the network, it is possible to search for information (web pages, etc.) from among the arbitrarily large number of web pages made public on the Internet. It is consequently possible to obtain the error recovery information of the network apparatus from among the arbitrarily large number of web pages made public on the Internet by storing an appropriate keyword in the keyword storing device. For example, in the case where the address of the error recovery information has been changed, it may be possible to obtain the changed address of the error recovery information. Further, in the case where the error recovery information has been deleted or the public service of the error recovery information has ended, it may be possible to obtain error recovery information on the Internet made public by a third party. This network apparatus has a high likelihood of being able to obtain the error recovery information even if the error recovery information cannot be obtained in spite of accessing the address stored in the address storing device.

### BRIEF DESCRIPTION OF THE DRAWINGS

FIG. 1 is a block view showing a schematic configuration of a printer 10.

FIG. 2 is a view showing information represented by an error information database 170.

FIG. 3 is a flow chart showing processes executed by the printer 10 when an error has occurred.

FIG. 4 is a flow chart showing a sub routine executed in step S6.

FIG. 5 is a flow chart showing a sub routine executed in step S10.

### DETAILED DESCRIPTION OF THE INVENTION

### Embodiment

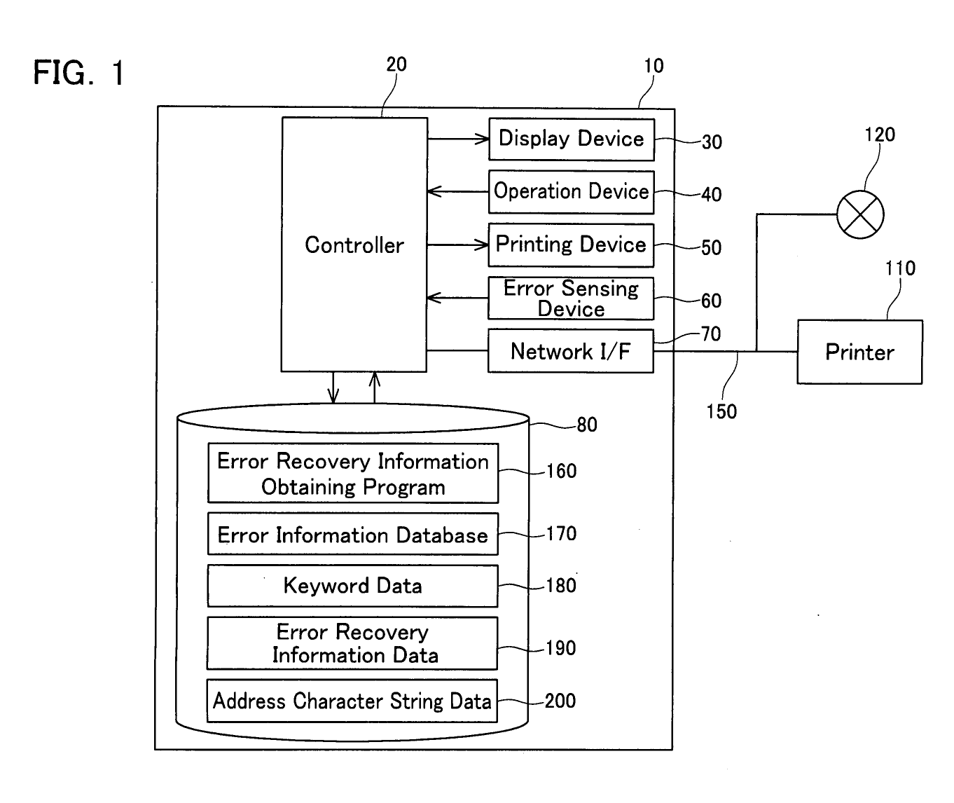

A printer of the embodiment will be described. FIG. 1 is a block view showing a schematic configuration of a printer 10 of the present embodiment. As shown in FIG. 1, the printer 10 is connected with the Internet 120 and a printer 110 by a communication network 150.

### (Configuration of Printer 10)

The printer 10 comprises a controller 20, a display device 30, an operation device 40, a printing device 50, an error sensing device 60, a network I/F 70, and a storing device 80.

The controller 20 consists chiefly of a CPU, ROM, RAM, etc. The controller 20 is connected with the display device 30, the operation device 40, the printing device 50, the error sensing device 60, the network I/F 70, and the storing device 80. The controller 20 exerts control over operation, communication with external machines, and the parts of the printer 10.

The display device 30 is a liquid crystal display and displays information in accordance with orders input from the controller 20.

The operation device 40 consists of a plurality of input buttons, etc. Orders are input from the operation device 40 to the controller 20 by means of input buttons operated by a user.

The printing device 50 consists chiefly of a paper tray, a paper feeding mechanism, an ink jet head, an ink jet head driving mechanism, etc. The printing device 50 feeds paper housed in the paper tray to the ink jet head, and the ink jet head prints an image on the paper. The printing device 50 executes printing in accordance with orders input from the controller 20.

The error sensing device 60 consists of a plurality of sensors and the like disposed at parts of the printer 10. When an error (paper jam, toner out, paper out, out of order, etc.) occurs in the printer 10, this error is sensed by one of the sensors. When an error has been sensed by the error sensing device 60, a signal corresponding to the sensed error is input from the error sensing device 60 to the controller 20.

The communication network 150 is connected with the network I/F 70. Further, the network I/F 70 is connected with the controller 20. Data transmission between the controller 20 and an external machine (for example, the printer 110 or the Internet 120) is performed via the network I/F 70. That is, the controller 20 is connected with the printer 110 or the Internet 120 via the network I/F 70.

The storing device 80 is capable of storing data. The data stored by the storing device 80 is read by the controller 20. Further, the storing device 80 receives data input from the controller 20, and stores this data. The storing device 80 stores an error recovery information obtaining program 160, an error information database 170, keyword data 180, a plurality of items of error recovery information data 190, and address character string data 200.

The error recovery information obtaining program 160 is a program for executing a process to obtain error recovery information from the controller 20.

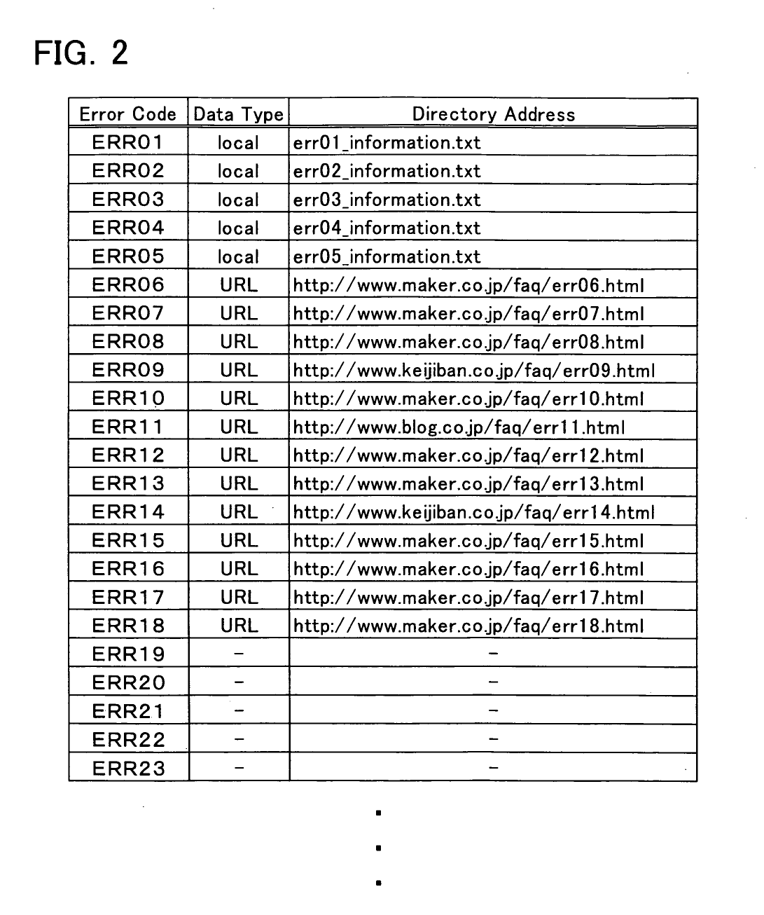

FIG. 2 shows an example of contents of the error information database 170. As shown in FIG. 2, the error information database 170 is data in which error codes and directory addresses corresponding to the error codes are described. The error codes show types of error. The directory addresses are addresses showing the location of the error recovery information corresponding to the error code (i.e. to the type of error). Moreover, the data type of FIG. 2 shows the type of directory address. The “local” data type shows that the directory address is an address within the storing device 80. The “URL” data type shows that the directory address is an address on the Internet 120. Further, as shown, there are also error codes for which a directory address is not described.

The keyword data 180 consists of printer name data and manufacturer name data. The printer name data is data describing an address character string showing the name of the printer 10. The manufacturer name data is data describing an address character string showing the name of the manufacturer of the printer 10.

The error recovery information data 190 is data showing the error recovery information for an identified error type. The storing device 80 stores a plurality of items of error recovery information data 190. The addresses of the error recovery information data 190 are cataloged in the error information database 170. Addresses that are the “local” data type are addresses showing the location of the corresponding error recovery information data 190 within the storing device 80.

The address character string data 200 is data in which an alphabetical character string is described. In the present embodiment, the address character string data 200 is data showing the character string “http://www.maker”. The character string “http://www.maker” is a character string that is shared in the addresses of various web pages made public on the Internet 120 by the manufacturer of the printer 10. That is, web pages present at the addresses that include the address character string http://www.maker are web pages made public by the manufacturer of the printer 10.

### (Operation of Printer 10)

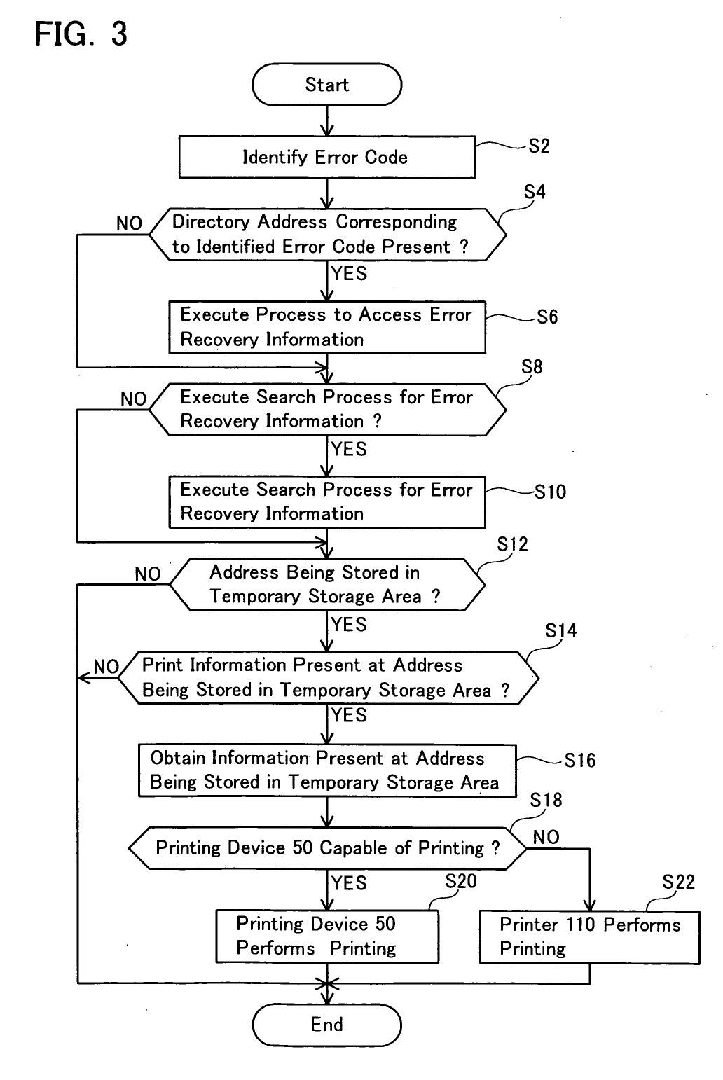

Next, the operation of the printer 10 will be described when the occurrence of an error has been sensed by the error sensing device 60. When an error has occurred in the printer 10, the error is sensed by the error sensing device 60. A signal corresponding to the sensed error is input from the error sensing device 60 to the controller 20. Thereupon, the controller 20 reads the error recovery information obtaining program 160 from the storing device 80, and executes the error recovery information obtaining program 160. The controller 20 executes the processes shown in the flow chart of FIG. 3 by executing the error recovery information obtaining program 160.

In step S2, the controller 20 identifies the error code of the sensed error. That is, the error information database 170 is read from the storing device 80. Further, the type of error is identified based on the signal input from the error sensing device 60. The error code corresponding to the identified error type is identified from among the error codes stored in the error information database 170.

When the error code has been identified in step S2, the controller 20 determines whether the directory address corresponding to the identified error code is present in the error information database 170 (step S4).

In the case where the directory address corresponding to the identified error code is present, the controller 20 executes a process to access the error recovery information (step S6). For example, as shown in FIG. 2, the directory address “err01_information.txt” is present, corresponding to the error code ERR01. As a result, in the case where the identified error code is ERR01, the controller 20 determines YES in step S4, and executes step S6.

In the case where the directory address corresponding to the identified error code is not present (for example, in the case of ERR20 of FIG. 2), the controller 20 determines NO in step S4, and executes step S8.

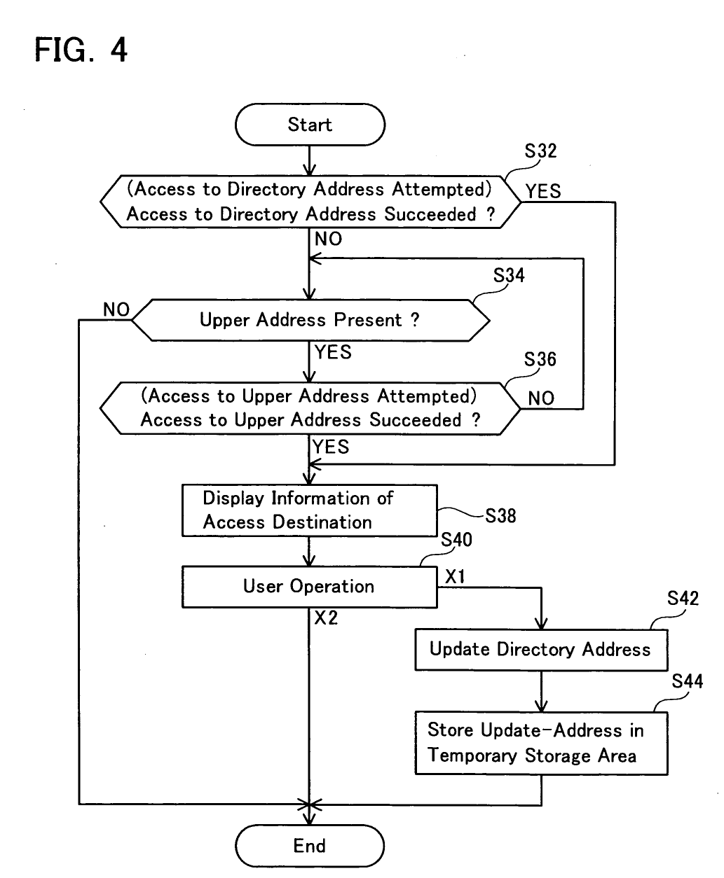

In step S6, the controller 20 executes the process to access the error recovery information. Step S6 is performed by executing the sub routine of FIG. 4.

In step S32, the controller 20 tries to access the directory address corresponding to the error code identified in step S2 (below, this will be termed the identified directory address). If information is present in the identified directory address, the controller 20 obtains the information present in the identified directory address, and displays the obtained information on the display device 30 (step S38). Moreover, in the case where the data type of the directory address identified in step S4 is “local”, the access of step S32 will definitely be successful. As a result, access in step S32 will fail only in the case where the data type of the identified directory address is “URL” and a web page is not present in the identified directory address (i.e. in the case where the web page has been moved or deleted).

If a web page is not present in the identified directory address (i.e. if access to the identified directory address fails), the controller 20 determines whether an upper address of the identified directory address is present (step S34). The determination as to whether the upper address is present is determined by whether “/” (a slash) is present in a character string after “http://” of the identified directory address. If the upper address is present (i.e. if “/” is present), the controller 20 tries to access an address one level up from the identified directory address (step S36). That is, the controller 20 tries to access an address in which the character string after “/” at the side furthest to the right (furthest toward the end) of the identified directory address has been deleted. For example, in the case of the directory address “http://www.maker.co.jp/faq/err10.html” (corresponding to the error code ERR10 of FIG. 2), the character string “/err10.html” is deleted from the directory address, and the controller 20 tries to access the upper address “http://www.maker.co.jp/faq”. If access in step S36 succeeds, the controller 20 obtains the web page that is present in this upper address, and displays the obtained web page on the display device 30 (step S38).

If access to the upper address fails in step S36, the controller 20 executes step S34 again. In step S34 that is executed from the second time onward, it is determined whether there is an address one level up from the upper address for which access failed in the previous step S36. In the case where there is an address one level up from the upper address, access to that address is tried in step S36. Unless access is successful, the controller 20 executes step S34 and step S36 repeatedly, trying each time to access an address that is one level further up. In the case where step S34 and step S36 have been executed repeatedly until there is no upper address (i.e. the case where access to the top address has failed), NO is determined in step S34 (for example, the top address of “http://www.maker.co.jp/faq/err10.html” is “http://www.maker.co.jp”). In this case, the controller 20 ends the sub routine of FIG. 4.

When access to the identified directory address or the upper address is successful in steps S32 to S36, the controller 20 displays information that is present at the accessed address (the error recovery information data 190 that is being stored in the storing device 80 or the web page on the network) on the display device 30 (step S38). When the controller 20 displays the information on the display device 30, the controller reaches a state of waiting for input from the user (step S40). When the user operates the operation device 40, the controller 20 changes the display on the display device 30 in accordance with the order input from the operation device 40. For example, in the case where a link has been pasted to the information shown in step S38, the user can order to display the information of the link destination by operating the operation device 40. Thereupon, the controller 20 displays the information of the link destination on the display device 30. The user can thus search for desired information by operating the operation device 40 while verifying the information on the display device 30.

Further, the operation device 40 comprises a directory button and a cancel button. When the user presses the directory button, the controller 20 executes step S42 as shown by the arrow X1 in FIG. 4. In step S42, the controller 20 identifies the address in the information being displayed on the display device 30 at the time when the directory button was pressed as an update-address. The controller 20 updates the identified directory address (i.e. the directory address corresponding to the error code identified in step S2) of the directory addresses stored in the error information database 170 to the identified update-address. When the user has discovered the error recovery information corresponding to the occurred error type, the user can update the directory address of the error information database 170 to the address of the discovered error recovery information by pressing the directory button. By updating the directory address to the update-address in this manner, the error recovery information can be displayed immediately in step S38 when the same error later occurs in the printer 10. When step S42 is executed, the controller 20 stores the identified update-address in a temporary storage area within the controller 20 (step S44), and the sub routine of FIG. 4 ends.

Further, when the user presses the cancel button while step S40 is being executed, the controller 20 ends the sub routine of FIG. 4 as shown by the arrow X2. The cancel button is utilized when the user cannot find the error recovery information, etc.

When the controller 20 ends the sub routine of FIG. 4, the step S8 of FIG. 3 is executed.

In step S8, the controller 20 determines whether a search process for the error recovery information is to be executed. The controller 20 determines NO in step S8 when the directory button has been pressed in step S6. In this case, the controller 20 executes step S12. When the directory button has not been pressed in step S6, or when there was no directory address corresponding to the error code identified in step S2 (i.e., when NO was determined in step S4), the controller 20 determines YES in step S8.

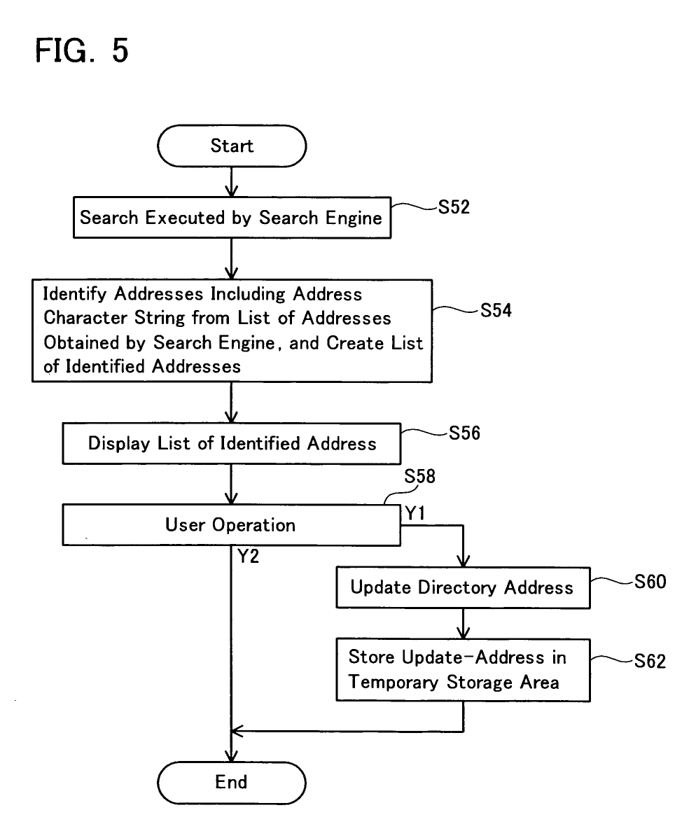

When YES is determined in step S8, the controller 20 executes the search process for the error recovery information (step S10). Step S10 is performed by executing the sub routine of FIG. 5.

In step S52, the controller 20 accesses an address of a search engine on the Internet 120 that is being stored by the storing device 80. Further, the controller 20 reads the keyword data 180 from the storing device 80. Thereupon the controller 20 sends the keyword data 180 (i.e., the printer name data and the manufacturer name data) and the error code identified in step S2 to the search engine. That is, the search engine is made to execute a search using the printer name, the manufacturer name, and the error code as keywords. The search engine thus outputs a list of addresses of web pages that include the printer name, the manufacturer name, and the error code from among the arbitrarily large number of web pages made public on the Internet 120. The controller 20 receives the list of addresses output from the search engine.

In step S54, the controller 20 reads the address character string data 200 (i.e. the data showing the address character string “http://www.maker”) from the storing device 80. Then the controller 20 identifies addresses having the address character string “http://www.maker” from among the list of addresses output by the search engine and creates a list of the identified addresses in step S54. A list is thus created in which only the addresses of more reliable web pages have been extracted from the list of addresses output by the search engine. The controller 20 displays the list of extracted addresses on the display device 30 (step S56).

When step S56 has been executed, the controller 20 reaches a state of waiting for input from the user (step S58). An address can be selected by the user operating the operation device 40 while verifying the information on the display device 30. That is, the web page in which the selected address is present can be verified.

When the user presses the directory button, the controller 20 executes step S60 as shown by the arrow Y1 in FIG. 5. In step S60, the controller 20 identifies the address of the web page that was being displayed on the display device 30 at the time when the directory button was pressed as an update-address. Thereupon, the identified directory address stored in the error information database 170 (the directory address corresponding to the error code identified in step S2) is reloaded with the update-address. When step S60 is executed, the controller 20 stores the identified update-address in the temporary storage area within the controller 20 (step S62), and the sub routine of FIG. 5 ends.

Further, when the user presses the cancel button while step S58 is being executed, the controller 20 ends the sub routine of FIG. 5 as shown by the arrow Y2.

When the controller 20 ends the sub routine of FIG. 5, step S12 of FIG. 3 is executed.

In step S12, the controller 20 determines whether an address is being stored in the temporary storage area within the controller 20. In the case where an address is not being stored in the temporary storage area (i.e. in the case where useful error recovery information could not be obtained), the controller 20 ends the process of FIG. 3 (NO in step S12). In the case where an address is being stored in the temporary storage area, the controller 20 makes the display device 30 display a message demanding selection of whether the information present at the address stored in the temporary storage area (i.e. error recovery information discovered by the user) is to be printed (step S14). If the user operates the operation device 40 to select that printing not be performed, the controller 20 ends the process of FIG. 3 (NO in step S14). In the case where the user selects printing, the controller 20 obtains the information present in the address that is being stored in the temporary storage area (step S16). Next, it is determined whether the printing device 50 is in a usable state (step S18). If the printing device 50 is in a usable state, the obtained information is printed by the printing device 50 (step S20). Further, if the printing device 50 is not in a usable state (i.e. NO in step S18), the controller 20 sends the obtained information to the printer 110, and the printer 110 prints this information (step S22). As a result, the user can start the error recovery of the printer 10 while verifying the printed error recovery information.

As described above, when the occurrence of an error has been sensed by the error sensing device 60, the printer 10 of the present embodiment tries to access the directory address (the directory address corresponding to the error that has occurred) that is stored in the storing device 80. As a result, in the case where access was successful, it is possible to retrieve the error recovery information corresponding to the error that has occurred.

Further, in the case where access to the directory address fails due to the address of the error recovery information having been changed, etc., the printer 10 tries to access the upper address of the directory address. The user can consequently search for, from the web page of the upper address, the error recovery information corresponding to the occurred error. In particular, in the case where access has failed, the printer 10 tries to access an address one level up from the address to which access failed. Attempts to access are made repeatedly, each time trying to access an address that is one level further up, until access is successful or access to the top address has failed. As a result, unless access is successful, attempts are made to access all the upper addresses. It is consequently highly probable that a web page relating to the error recovery information can be accessed.

Further, in the case where access of the directory address (and the upper address) has failed and an error has occurred for which there is no corresponding directory address, the printer 10 sends a keyword to the search engine on the Internet 120. Thereupon, a search is made from the web pages made public on the Internet 120 for web pages that include the keyword that was sent. As a result, it is possible to obtain error recovery information corresponding to the occurred error from the search results output by the search engine (a list of addresses of web pages that include the keyword). That is, error recovery information corresponding to the error that has occurred can be obtained even in the case where the address of the error recovery information has been changed, etc.

Further, the printer 10 causes the search engine to execute a search using the name of the printer, the name of the manufacturer, and the error code as keywords. As a result, a list of addresses of appropriate web pages is output from the search engine, and satisfactory error recovery information can be obtained.

Further, the printer 10 identifies addresses that include the address character string “http://www.maker” from among the list of addresses output by the search engine, and outputs a list of identified addresses. That is, the addresses of web pages with a low level of reliability are not input into the list of identified addresses. The user can thus search for the error recovery information more satisfactorily.

Further, when the user has pressed the directory button of the operation device 40, the printer 10 identifies the information being displayed on the display device 30 as an update-address. Thereupon, the printer 10 updates the identified directory address (i.e. the directory address corresponding to the occurred error) of directory addresses stored in the error information database 170 to the update-address. When the same type of error occurs later, the error recovery information corresponding to that error can consequently be obtained immediately.

In the embodiment described above, a list of addresses that includes the address character string “http://www.maker” is created from the list of addresses output by the search engine. However, an address character string may be set for each error type. For example, there may be a differing manufacturer for each of the parts of the printer 10 (for example, the manufacturer of the display device 30, the manufacturer of the printing device 50, the manufacturer of the network I/F 70, etc.), and these manufacturers may make error recovery information public for each of the parts. In this case, a more reliable list of addresses can be created by setting an address character string for each error type.

Further, addresses that include the address character string may not be extracted, and the list of addresses output by the search engine may be displayed as is on the display device 30. Since the list of addresses has a low level of reliability with this type of configuration, it is difficult for the user to search for the error recovery information. However, since the addresses of web pages made public by a third party are also included in the list, the error recovery information can be obtained from this type of web page.

With the printer 10 described above, the data that is being stored in the storing device 80 may be input by the manufacturer of the printer 10, or may be input by the user of the printer 10 after purchase.

A part of the technique disclosed in the above embodiment will be described below.

(1) The keyword storing device may store a name of the network apparatus, a name of a manufacturer of the network apparatus, and error codes corresponding to error types. In the case where an error occurrence has been sensed by the error sensing device, the search device may send the name of the network apparatus, the name of the manufacturer of the network apparatus, and the error codes corresponding to the type of error whose occurrence was sensed to a search engine on the network, and obtains a result of the search.

(2) The network apparatus may further comprise a selecting device that allows a user to select at least one address from the list of the addresses output by the search device. The address storing device may update the stored address, corresponding to the type of error whose occurrence was sensed, to the address selected by the user.

(3) The access device may try to access an upper address of the address in the case where the access device fails to access the address being stored by the address storing device. In the case where there is a plurality of upper addresses, the access device may try to access all the upper addresses, or may try to access a portion of the upper addresses. For example, the address “aaa.com/bbb/ccc” has two upper addresses: the address “aaa.com/bbb” and the address “aaa.com”. In the case where the access device fails to access the address “aaa.com/bbb/ccc”, the access device may try to access either one of the two upper addresses or may try to access both of the two upper addresses.

A specific example is presented above, but this merely illustrates some possibilities and does not restrict the technique disclosed in the present specification.

What is claimed is:

1. A network apparatus to be connected with a network, the network apparatus comprising:
an address storing device that stores an address of a web page on the network;
a keyword storing device that stores a keyword related to the network apparatus;
an error sensing device that senses error occurrence in the network apparatus;
an access device that tries to access the address in the case where the error sensing device senses the error occurrence;
a search device that sends the keyword to a search engine on the network and receives a result of the search in the case where the access device fails to access the address; and
an output device that outputs the result.

2. The network apparatus as in claim 1, wherein:
the access device tries to access an upper address of the address in the case where the access device fails to access the address; and
the search device sends the keyword to the search engine and receives the result in the case where the access device fails to access the upper address.

3. The network apparatus as in claim 2, wherein:
the access device repeatedly performs an operation until the access device succeeds in accessing any address or fails to access a top address of the address, wherein the operation is one that tries to access an address one level up from a failed address; and
the search device sends the keyword to the search engine and receives the result in the case where the access device fails to access the top address.

4. The network apparatus as in claim 1, wherein:
the result comprises a list of addresses of web pages including the keyword;
the network apparatus further comprises a selecting device that allows a user to select at least one address from the list of the addresses; and
the address storing device updates the stored address to the selected address.

5. The network apparatus as in claim 1, further comprising:
an address character string storing device that stores an address character string,
wherein:
the result comprises a list of addresses of web pages including the keyword; and
the output device identifies addresses including the address character string from the list of the addresses and outputs a list of the identified addresses.

6. The network apparatus as in claim 1, wherein
the keyword storing device stores at least one of a name of the network apparatus and a name of a manufacturer of the network apparatus.

7. The network apparatus as in claim 1, wherein:
the keyword storing device stores error codes corresponding to error types; and
the search device sends the keyword including an error code corresponding to a type of occurred error.

8. The network apparatus as in claim 1, wherein:
the address storing device stores addresses corresponding to error types; and
the access device tries to access an address corresponding to a type of occurred error.

9. A network apparatus to be connected with a network, the network apparatus comprising:
an address storing device that stores an address of a web page on a network;
an error sensing device that senses error occurrence in the network apparatus;
an access trying device that tries to access the address in the case where the error sensing device senses the error occurrence;
an access device that tries to access an upper address of the address in the case where the access trying device fails to access the address.

10. A network apparatus to be connected with a network, the network apparatus comprising:
a keyword storing device that stores a keyword related to the network apparatus;
an error sensing device that senses error occurrence in the network apparatus;
a search device that sends the keyword to a search engine on the network and receives a result of the search including a list of addresses of web pages including the keyword in the case where the error sensing device senses the error occurrence;
an address character string storing device that stores an address character string; and
an output device that identifies addresses including the address character string from the list of the addresses obtained by the search device, and outputs a list of the identified addresses.
